(19) United States
(12) Patent Application Publication
(10) Pub. No.: US 2005/0056115 A1
(43) Pub. Date: Mar. 17, 2005

(54) Pedal assembly retracting in a front vehicular impact

(75) Inventors: Victor Da Silva, Suresnes (FR); Silvio Endrizzi, Den Haag (NL); Laurent Chan-Ng-Yok, Puteaux (FR); Jean-Michel Humbert, Neuilly Sur Marne (FR); Bruno Piranda, Vennans (FR); Chris Jagger, Wakefield (GB)

Correspondence Address: LEYDIG VOIT & MAYER, LTD, 700 THIRTEENTH ST. NW, SUITE 300, WASHINGTON, DC, 20005-3960, US

(73) Assignee: BCK TECHNOLOGY LTD, Scunthorpe (GB)

(21) Appl. No.: 10/844,596

(22) Filed: May 13, 2004

(30) Foreign Application Priority Data
May 19, 2003 (FR) 03 05 964

(51) Int. Cl. G05G 1/14

(52) U.S. Cl. 74/512

(57) ABSTRACT

The invention relates to the field of automobile driver safety in case of front impact to the automobile.

The device includes means (11) of connection by lateral translation of plates (4 and 6) parallel to their shaft of rotation (5) and means of disconnection (8, 9) acting on the means of connection in order to disconnect the plates in case of front impact to the vehicle by allowing a respective separating movement via lateral translation of the plates parallel to their axes of rotation and bringing about their disconnection.

In case of front impact to the vehicle, the clutch or brake pedal (2) tilts towards bottom wall of the foot well.

The present invention pertains to the field of automobile driver safety in case of front impact to an automobile.

With an ordinary type pedal assembly, the brake pedal and the clutch pedal are directly connected to pedal assembly shafts. The pedal assembly is attached to the structure of the vehicle, and the pedals are respectively connected to the brake and clutch control rods. In case of front impact, the structure of the vehicle and therefore the dashboard that supports the pedal assembly, deform, leading to a raising of the pedal assembly into the legs of the driver, which can cause lesions to the lower limbs, possibly to the point of fracture.

The device according to the invention is provided in order to limit the raising of the pedal assembly in case of front impact, thus improving driver protection. It should be noted on this subject that it is possible for the pedal assembly not to have a clutch pedal (the case of automatic transmission vehicles), but only a brake pedal.

Thus, the present invention pertains to a pedal assembly device which is retractable in case of front impact to a vehicle, which has a pedal assembly support mounted on the dashboard of the vehicle in the footwell of the vehicle and articulated on which are at least one control lever of the clutch pedal and/or brake pedal.

In order to solve the problem indicated above, the device is characterized in that the control lever of the clutch pedal and/or brake pedal has a control plate with a horizontal rotary shift perpendicular to the longitudinal axis of the vehicle and mounted on which is a counter-plate for a control rod connected to this plate and acting on the clutch or the brake, and in that a means of connection by lateral translation of the plates parallel to their axes of rotation is provided, as well as a means of disconnection acting on the connection means in order to disconnect these plates in case of front impact to the vehicle while allowing the respective movement of separation by lateral translation of the plates parallel to their axes of rotation and bringing about their disconnection, so that in the absence of a front impact to the vehicle, the two plates remain connected, and an action on the control lever of the pedal leads said control rod to act on the clutch or the brake, whereas in case of front impact to the vehicle, the disconnection of the plates from one another leads the pedal to tilt towards the bottom wall of the foot well under its own weight or by means of a torsion spring.

According to other advantageous characteristics of the invention:
the control lever of the pedal has a finger capable of moving in an opening formed in the counter-plate and limiting the relative rotation of the two plates during their disconnection;
the connection means includes at least two fastening pins perpendicularly passing through the two plates and connecting them to one another;
the length of the finger is greater than that of the fastening pins so as to allow axial separation of the plates and the transmission of power from the control lever to the control rod subsequent to triggering of the device;
the disconnection means comprises a separation plate mounted on said rotary shaft between the control plate and the counter-plate and connected to a radial arm, where the fastening pins pass perpendicularly through the three plates in order to form an assembly of coupled plates and where the opposing faces of the control plate and/or of the counter-plate and of the separation plate, which respectively comprise ramps and counter-ramps, which cooperate in case of front impact to the vehicle which reverberates onto the radial arm by means of a piece connected to the structure of the vehicle, in order to bring about the pivoting of the radial arm and the axial separation of the control plate and/or the counter-plate with respect to the separation plate by rupture of the fastening pins of the three plates;
the piece connected to the structure of the vehicle is placed a predetermined distance from the radial arm and is guided to recoil in order to collide with this arm while leading it to pivot, so that the cam movement of said ramps and counter-ramps ensures a rupturing tension of the fastening pins and a respective movement of lateral translation of the control plate and/or counter-plate with respect to the separation plate, resulting in disconnection of the control plate and of the counter-plate from one another and guiding the pedal to tilt toward the bottom wall of the foot well under its own weight or by means of a torsion spring;
the fastening pins are connected to the counter-plate or the control plate and connect the three plates coupled together by their ends in the form of a flange which breaks in case of separation of the control plate and/or of the counter-plate with respect to the separation plate;
the piece connected to the structure of the vehicle is an element which is rigidly connected to the crosspiece of the instrument panel of the vehicle, such as a column support intended for maintaining the steering column with respect to said crosspiece;
the plates are produced by drawing/counter-drawing in order to form stubs in the form of ramps and drawn parts in the form of slots delimiting said ramps and counter-ramps;
the plates are produced from injected plastic material in order to form stubs in the form of ramps and drawn parts in the form of slots delimiting said ramps and counter-ramps;
the radial arm is produced from metal, and for example, from steel;
the radial arm is produced from plastic material;
a washer is interposed between the control plate and the counter-plate with the same thickness as the tilter, which, for this purpose contains a bore for receiving the washer, with free rotation between the tilter and the washer;
the washer has on each side at least two pins, where the pins located on the side of the control plate are force-fit in corresponding openings of said plate, and the pins on the side of the counter-plate are mounted so as to slide in corresponding openings of this plate;
the washer and the pins are preferably formed from metal;
rivets, at least two in number, pass through the control plate, the tilter and the counter-plate in order to connect the assembly in the transverse direction in the absence of impact, where these rivets slide in openings provided in the tilter, allowing the latter, in case of impact, to rotate under the influence of the aforementioned piece connected to the structure of the vehicle without moving the clutch or brake pedal at the same time;
a key system is provided in place of the washer.

The invention will be better understood and other aims, characteristics, details and advantages will appear more clearly in the course of the following explanatory description with reference to the appended drawings, given only as an example for illustrating an embodiment of the invention, wherein:

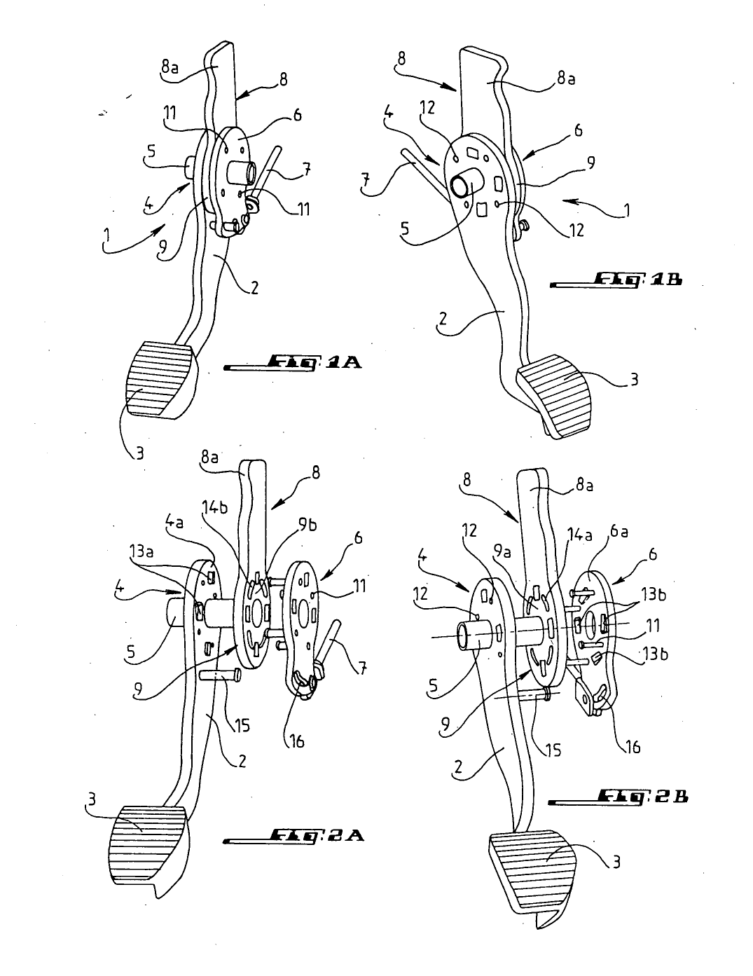

FIG. 1 A is a perspective view as seen from the right of a pedal assembly device according to the invention and shows a counter-plate connected to the control lever of the clutch or brake pedal for control of the clutch or brake of a vehicle in the absence of front impact;

FIG. 1B shows the same pedal assembly device as seen from the left;

FIG. 2A shows the pedal assembly device of FIG. 1A in the disassembled state, after front impact to the vehicle;

FIG. 2B shows the pedal assembly device of FIG. 1B in the same state as that of FIG. 2A;

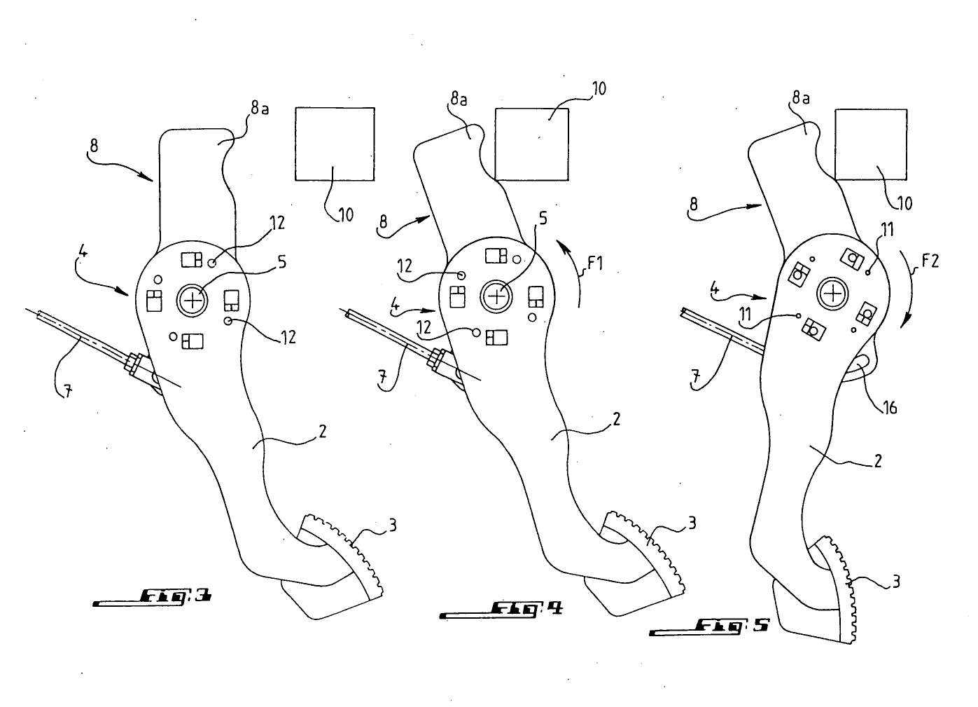

FIG. 3 is a schematic view of the assembled pedal assembly device according to FIGS. 1A and 1B as seen from the side of the clutch or brake pedal in the absence of front impact, and in particular shows a radial arm already illustrated in the preceding figures, which follows the movement of the control lever of the clutch or brake pedal and brings about the rotation of the counter-plate to which it is connected;

FIG. 4 is a view similar to FIG. 3 at the beginning of a front impact, where the radial arm of FIG. 3 has not yet cooperated with a piece connected to the structure of the vehicle in order to bring about disconnection of the control lever of the clutch or brake pedal and the counter-plate;

FIG. 5 is a view similar to FIG. 4 at the end of a front impact, where the radial arm has cooperated with the piece connected to the structure of the vehicle in order to bring about disconnection of the clutch or brake pedal and the counter-plate according to FIGS. 2A and 2B and the tilting of the pedal which is free to rotate;

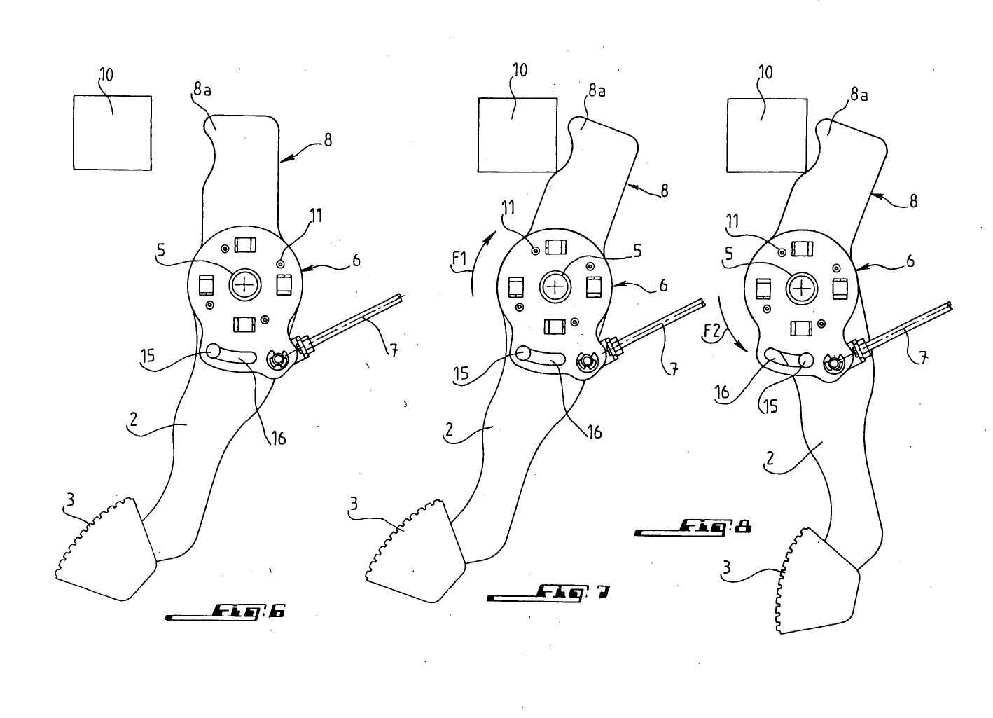

FIG. 6 is a schematic view of the assembled pedal assembly according to FIGS. 1A and 1B as seen from the counter-plate side in the absence of a front impact, with the radial arm which follows the movement of the control lever of the clutch or brake pedal and brings about the rotation of the counter-plate to which it is connected;

FIG. 7 is a view similar to FIG. 6 at the beginning of a front impact, where the radial arm of FIG. 6 has not yet cooperated with the piece connected to the structure of the vehicle in order to bring about disconnection of the control lever of the clutch or brake pedal and the counter-plate;

FIG. 8 is a view similar to FIG. 7 at the end of a front impact, where the radial arm has cooperated with the piece connected to the structure of the vehicle in order to bring about disconnection of the clutch or brake pedal and the counter-plate according to FIGS. 2A and 2B, and shows a finger connected to the control lever of the clutch or brake pedal at the end of its course of travel in an opening made in the counter-plate, so that the pedal can again fulfill its function of moving the counter-plate after tilting of the pedal;

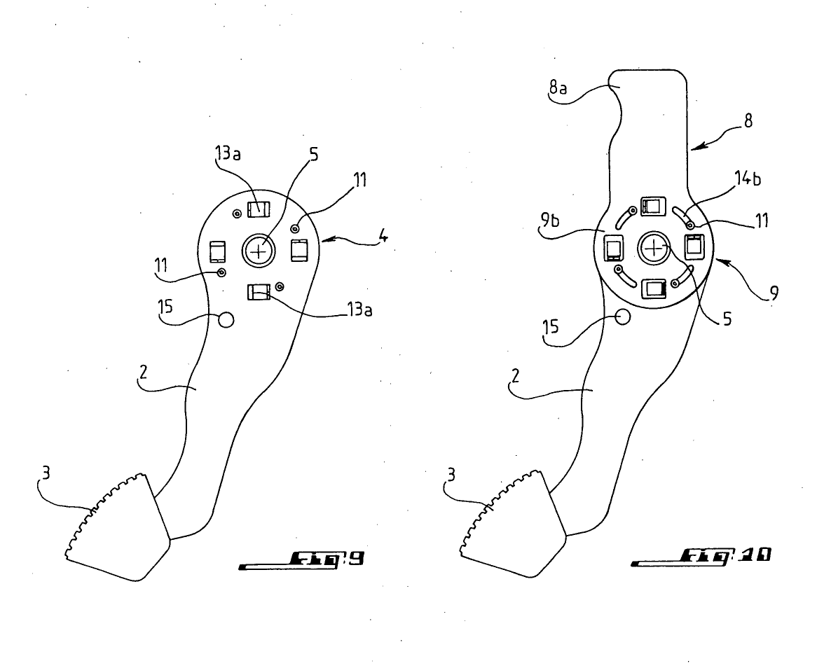

FIG. 9 is a separate view of the control lever of the clutch or brake pedal of the preceding figures;

FIG. 10 is a view similar to FIG. 6 before mounting of the counter-plate;

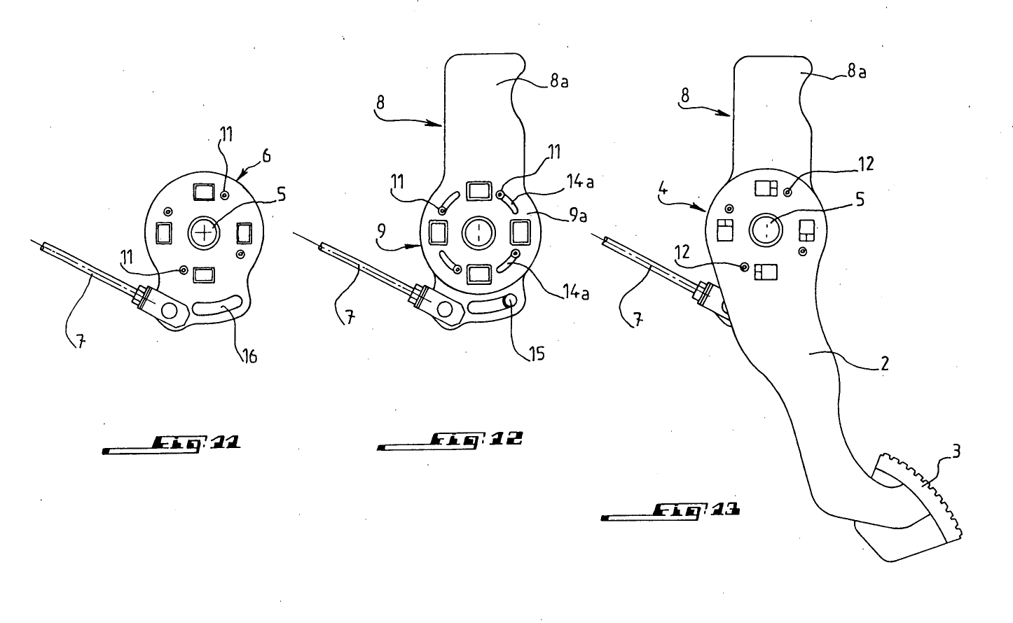

FIG. 11 is a separate view of the counter-plate of the preceding figures;

FIG. 12 is a view similar to FIG. 3 before mounting of the control lever of the clutch or brake pedal, but for explanatory reasons shows a guide finger connected to the control lever;

FIG. 13 is a view similar to FIG. 3 but before mounting of the pedal assembly in the passenger space of the vehicle, so that the piece connected to the structure of the vehicle which is led to cooperate with the radial arm in case of front impact is left out; and

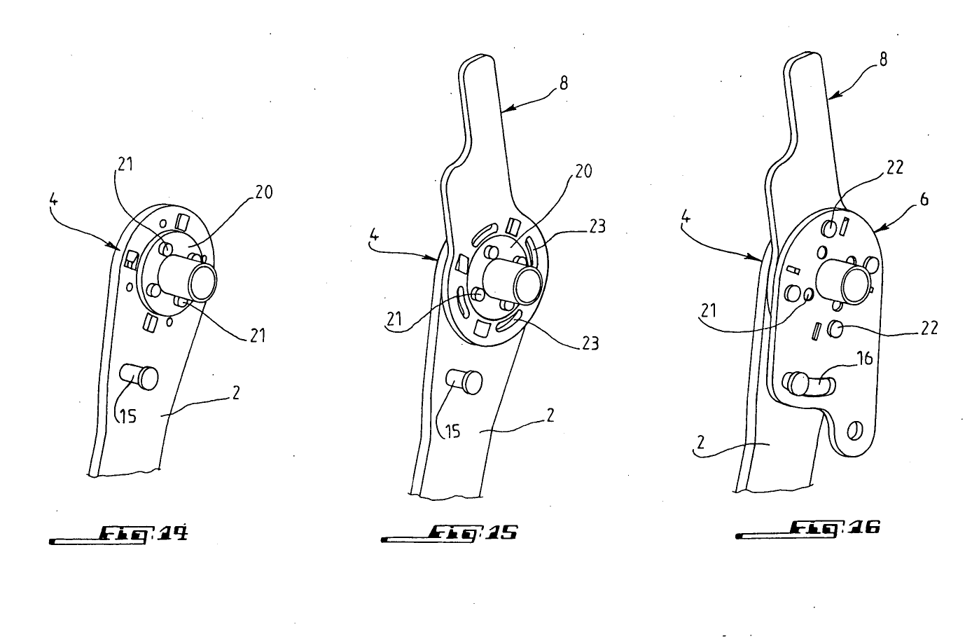

FIGS. 14 to 16 represent a modification of the pedal assembly device of the preceding figures suited to a variant of transmission of force.

In a known manner for any pedal assembly, the pedal assembly according to the invention, which is retractable in case of front impact to a vehicle, has a pedal assembly support maintained on the dashboard of the vehicle in the foot well thereof and articulated on which is at least one control rod of the brake pedal as well as, in general, a control lever of the clutch pedal, except in the case of an automatic transmission vehicle.

In the following, discussions of the control lever of the clutch or brake pedal are understood to include the case in which a control lever of the brake pedal and a control lever of the clutch pedal are provided or only the control lever of the brake pedal is provided.

Thus, in the drawings, the pedal assembly device referenced overall as 1 includes control lever 2 of clutch or brake pedal 3. Control lever 2 is connected to so-called control plate 4, which is mounted on shaft 5 constituting the shared shaft of pedal assembly device 1.

Counter-plate 6 is mounted on shaft 5 opposite control plate 4, and control rod 7 is connected to counter-plate 6 in order to act in a known manner on the clutch or brake system. For this purpose, counter-plate 6 and control plate 4 are joined together by a means of connecting via lateral translation, which will be treated below, and which is provided, according to the invention, for separating and disconnecting plates 4 and 6 from one another in case of front impact to the vehicle.

In order to realize the foregoing and according to the invention, radial arm 8 forming a tilter is provided, whose plate 9 is mounted on shaft 5 between control plate 4 and counter-plate 6. As seen particularly in FIGS. 3 and 6, where pedal assembly device 1 is represented in the state of normal operation in the position in which the plates are coupled according to FIGS. 1A and 1B, that is, before front impact, tilter 8 is a predetermined distance from piece 10, which is connected to the structure of the vehicle and which is generally an element rigidly connected to the crosspiece of the instrument panel of the vehicle, such as a column support intended for maintaining the steering column with respect to said crosspiece. In the following, piece 10 will therefore be simply called the column support, but it can be any piece connected to the structure of the vehicle.

As seen in the assembled state of FIGS. 1A and 1B and in the disassembled state in FIGS. 2A and 2B, the disconnection means of counter-plate 6 and control plate 4 consists of at least two fastening pins 11 which transversely pass through these two plates as well as so-called separation plate 9, for reasons which will appear in the following, which is placed between these plates in order to form an assembly of coupled plates.

In order to ensure this connection in the coupled state, fastening pins 11, which are four in number in the present embodiment, have one end connected, for example, to counter-plate 6 and pass through all of the plates in the manner of a rivet, where control plate 4 for this purpose has flange 12 in which the free end of fastening pin 11 is riveted. Quite obviously, one end of fastening pin 11 can be connected to control plate 4, whereas a flange will be provided on counter-plate 6 for riveting this pin.

According to the invention, and in order to realize the disconnection of counter-plate 6 with respect to control plate 4, these plates, which are preferably produced by drawing/counter-drawing or from injected plastic material, on their present opposing surfaces, a cooperating system of ramps and counter-ramps. Thus, as seen in the various figures, and particularly in FIGS. 2A and 2B, surface 4a of control plate 4 facing surface 9a of separation plate 9 has stubs 13a in ramp form, whereas this surface 9a has corresponding drawn parts in the form of circular slots 14a.

Likewise, surface 6a of counter-plate 6 facing surface 9b of separation plate 9 has stubs 13b in the form of ramps, whereas this surface 9b has corresponding drawn parts in the form of circular slots 14b.

On this subject, and although stubs 13a and 13b have been represented respectively on control plate 4 and on counter-plate 6, whereas slots 14a and 14b are provided on the respective surfaces of separation plate 9, it is possible to provide other means so that the surfaces of the various opposing plates have a cooperating pattern of ramps and counter-ramps. It is likewise possible, according to the invention, to provide such a pattern of ramps and counter-ramps only on opposing surfaces 4a and 9a of the control plate and of the separation plate or else only on opposing surfaces 6a and 9b of the counter-plate and of the separation plate.

The pedal assembly device as described above functions in a conventional manner in the absence of front impact. Control lever 2 of clutch or brake pedal 3, which the driver presses, rotates counter-plate 6 which controls the brake or clutch system by means of control rod 7. Tilter 8 is then moved freely by this rotational movement, and the forces applied by control lever 2 to counter-plate 6 are transmitted by fastening pins 11 which connect the assembly of plates 4, 6 and 9 as seen in FIGS. 1A and 1B.

On the other hand, in the event of a front impact to the vehicle, column support 10 which, as seen above, is used to maintain the steering column with respect to the crosspiece of the instrument panel, undergoes little or no deformation or recoil in comparison with the deformation or recoil undergone by the dashboard. It is recalled on this subject that the dashboard is a wall which connects the crosspiece of the instrument panel to the substructure of the vehicle and supports the pedal assembly. Thus, the recoil of the dashboard in case of front impact at the same time leads to the recoil of the pedal assembly, along with the disadvantages mentioned in the preceding in the absence of the pedal assembly device according to the invention which is retractable in case of a front impact.

Because of the device according to the invention, the recoil of the pedal assembly mentioned above causes free end 8a of tilter 8 to stop against column support 10 according to FIGS. 4 and 7, which tends to cause control lever 2 to rise according to arrow F1, the tilter then continuing its movement and finishing it according to FIGS. 5 and 8. This movement brings about the rotation of tilter 8 about shaft 5 of control lever 2. The pivoting of tilter 8 causes a cam movement between the stubs of plates 4 and 6 (or of just one of these plates) and the slots of separation plate 9 respectively facing one another, or in general, of the ramps and counter-ramps of the opposing surfaces of the corresponding plates. This cam movement then leads to rupturing tension on fastening pins 1 1, which break and emerge from their holding flange 12 in the corresponding plate. Such rupturing tension results in a respective movement of separation by lateral translation of control plate 4 and/or of counter-plate 6 with respect to so-called separation plate 9, leading to the relative disconnection of control plate 4 and counter-plate 6. Control lever 2 then becomes free to rotate about shaft 5, which leads the pedal to tilt according to arrow F2 toward the bottom wall of the foot well and entrains the clutch or brake pedal 3 to hit the floor under its own weight or by means of a torsion spring (not shown).

The above operation, in case of front impact, completely disconnects the brake system and the brake pedal. However, even if the pedal and the vehicle as a whole are a priori out of use after such an impact, it may be necessary to ensure that the brake pedal can still be actuated after disconnection of the control plate and the counter-plate.

In order thus to meet the regulatory constraints in particular or to reassure certain drivers concerning a possible untimely disconnection of the control plate and the counter-plate which would bring about the complete absence of braking, control lever 2 has finger 15 which, in the state in which these two plates are disconnected, can move in a curved opening 16 formed in the counter-plate, limiting the relative rotation of the two plates and allowing braking at the end of the course of travel of finger 15 in curved opening 16 (see FIGS. 8 and 15). In other words, when finger 15 comes to the end of its course of travel and stops against an end of opening 16, the pedal can again fulfill its function of moving counter-plate 6.

Quite obviously, the length of finger 15 is greater than that of fastening pins 11 so as to allow the axial separation of the plates, and on this subject, FIGS. 2A and 2B show a state of complete disconnection of the various elements of the device so that these elements are clearly visible but in a separated arrangement, particularly with finger 15 completely out of its opening.

Tilter 8, as well as its plate 9, together constituting the main part of the present invention, is preferably produced from steel. However, the tilter can also be produced from plastic material, since it does not contribute to the transmission of forces under ordinary conditions of use of the pedal assembly. It should be noted that in this embodiment, the transmission of rotary power can be only ensured by fastening pins 11, which pass through plates 4, 6 and 9. It is however, necessary for tilter 8 to have sufficient mechanical strength, on the one hand, so as not to break in case of impact against column support 10, and on the other hand, so as resist the cam force between the ramps and counter-ramps of the various opposing plate surfaces.

In another embodiment of the invention shown in FIGS. 14 to 16, washer 20 is provided, interposed between counter-plate 6 and control plate 4, where this control plate is connected to control lever 2 of the clutch or brake pedal and generally called the pedal unit. Washer 20 has the same thickness as tilter 8 which has a hole capable of receiving this washer. Each side of washer 20 has at least two pins 21, for example, four pins as shown in the figures, where pins 21 located on the side of control lever 2 of the pedal are force-fit in corresponding openings of pedal unit 4. Pins 21 located on the side of counter-plate 6 are mounted so as to slide in corresponding openings of the counter-plate, so as to be able to rotate this plate but be free to move translationally thereto according to the transverse axis. Note that there is free rotation between tilter 8 and washer 20.

Moreover, rivets 22, at least two in number, for example, four in the figures, which pass through the pedal unit or control plate 4, tilter 8 and counter-plate 6, are provided in order to maintain the assembly in the transverse direction in the absence of impact. The shafts of rivets 22 slide in openings 23 provided in tilter 8, as in the embodiment of the preceding figures, allowing tilter 8 to rotate in case of impact under the influence of the column support (see reference 10 of FIGS. 3 to 8) without simultaneously moving the pedal.

As in the embodiment of the preceding figures, tilter 8 can be produced from plastic material, whereas washer 20 and its pins 21 are preferably made of metal in order to ensure the transmission of rotary power.

Although not represented, in place of drive washer 20, it is possible to use any other equivalent means including, for example, a keyed system. It should be noted on this subject that the underlying idea is that the functions dissociate into the different components, which greatly facilitates the choice of material and dimensions.

In any case, the invention is not limited to the embodiment examples represented and described in detail since various modifications can be made to them, which are still within the scope of the invention.

1. A pedal assembly device which is retractable in case of front impact to a vehicle including the pedal assembly device, comprising:
a pedal assembly support mounted on a dashboard of a vehicle in a foot well of the vehicle and including at least one control lever of a clutch pedal and/or a brake pedal, the control lever including
a control plate with a horizontal rotary shaft perpendicular to a longitudinal axis of the vehicle, and
a counter-plate for a control rod connected to the control plate and acting on the clutch and/or the brake, the counter-plate being mounted on the horizontal rotary shaft,
means of for connecting, via lateral translation, the control plate and the counter-plate parallel to the non-horizontal rotary shaft
means for disconnecting, including a separation plate mounted on the rotary shaft between the control plate and the counter-plate, the means for disconnecting acting on the means for connecting to disconnect the control plate and the counter-plate in case of a front impact to the vehicle, while allowing a separating movement, by lateral translation of the control plate and the counter-plate parallel to their axis of rotation, bringing about their disconnection, so that before a front impact to the vehicle, the control plate and the counter-plate remain connected, wherein an action on the control lever of the clutch and/or brake pedal causes the control rod to act on the clutch and/or the brake pedal, and, in case of a front impact to the vehicle, disconnection of the control plate and the counter-plate from each other causes the clutch and/or brake pedal to tilt toward a bottom wall of the foot well.

2. The pedal assembly device according to claim 1, wherein the control lever of the pedal includes a finger for moving in an opening in the counter-plate and limiting relative rotation of the control plate and counter-plate during their disconnection.

3. The pedal assembly device according to claim 2, wherein the connection means includes at least two fastening pins that perpendicularly pass through the control plate and the counter-plate and connect the plates together.

4. The pedal assembly device according to claim 3, wherein the finger has a length greater than the fastening pins for axial separation of the control plate and the counter-plate and for transmission of force from the control lever to the control rod.

5. The pedal assembly device according to claim 1, including a radial arm forming a tilter connected to the separation plate fastening pins passing perpendicularly through and coupling the control plate, the counter-plate, and the separation plate, and ramps and counter ramps on opposing sides of the control plate and/or of the counter-plate and the separation plate, the ramps and counter-ramps cooperating in a front impact to the vehicle with the tilter through a piece connected to the vehicle, to pivot the tilter and axially separate the control plate and/or counter-plate with respect to the separation plate by rupturing the fastening pins.

6. The pedal assembly device according to claim 5, wherein the piece connected to the vehicle is located a predetermined distance from tilter and guided to recoil and collide with the tilter while guiding the tilter to pivot, so that cam movement of the ramps and counter-ramps ensures a rupturing tension on the fastening pins and respective lateral translation of the control plate and/or the counter-plate with respect to the separation plate, resulting in disconnection of the control plate and the counter-plate and the clutch and/or brake pedal to tilt towards a bottom wall of the foot well.

7. The pedal assembly device according to claim 5, fastening pins are connected to one of the counter-plate and the control plate and connect the control plate, counter-plate, and separation plate together by a flange which breaks in case of separation of the control plate and/or of counter-plate with respect to the separation plate.

8. The pedal assembly device according to claim 5, wherein the piece connected to the vehicle is rigidly connected to a cross-piece of an instrument panel of the vehicle.

9. The pedal assembly device according to claim 5, wherein the control plate, the counter-plate, and the separation plate are drawn to form the ramps and slots delimiting the ramps and counter-ramps.

10. The pedal assembly device according to claim 5, wherein the control plate, the counter-plate and the separation plate are plastic.

11. The pedal assembly device according to claim 5, wherein the tilter is metal.

12. The pedal assembly device according to claim 5, wherein the tilter is plastic.

13. The pedal assembly device according to claim 5, including a washer interposed between the control plate and the counter-plate having equal thickness with the tilter, the tilter having a bore for receiving the washer, the tilter and the washer freely rotating.

14. The pedal assembly device according to claim 13, wherein the washer has on each side at least two pins, which are located on a side of the control plate and force-fit in corresponding openings of the control plate, the pins on the side of the counter-plate sliding in corresponding openings of the counter-plate.

15. The pedal assembly device according to claim 14, wherein the washer and the pins are metal.

16. The pedal assembly device according to claim 5, including rivets passing through the control plate, the tilter and the counter-plate connecting the assembly the rivets sliding in openings in the tilter for, in case of an impact, rotation of the tilter under influence of the piece without simultaneously moving the clutch and/or brake pedal.

17. The pedal assembly device according to claim 13, including a keyed system in place of the washer.
